(19) United States
(12) Patent Application Publication
(10) Pub. No.: US 2008/0144007 A1
(43) Pub. Date: Jun. 19, 2008

(54) Thermal lens spectroscopy for ultra-sensitive absorption measurement

(75) Inventor: Alexander Kachanov, Sunnyvale, CA (US)

Correspondence Address: Herbert Burkard, BLDG. 1, 3350 Scott Blvd., Santa Clara, CA, 95054, US

(73) Assignee: Skymoon R&D, LLC.

(21) Appl. No.: 11/998,495

(22) Filed: Nov. 30, 2007

Related U.S. Application Data
(60) Provisional application No. 60/875,035, filed on Dec. 15, 2006.

(51) Int. Cl. G01J 3/00; G01N 21/00; G01J 3/44

(52) U.S. Cl. 356/51; 356/440; 356/301

(57) ABSTRACT

A thermal lens detection apparatus comprising: i) an optical cell for containing at least one target analyte present in a carrier liquid, ii) a probe beam having a pre-determined wavelength, iii) an excitation beam having a pre-determined wavelength shorter than that of the probe beam and a Rayleigh length approximately equal to the radius of said optical cell, the beam axis of said probe beam and the beam axis of said excitation beam being at an angle to each other but both the probe beam and excitation beam being focusable so that their beams overlap in the interior portion of the optical cell, iv) a signal photo-detector for receiving at least a portion of said probe beam signal after its passage through said optical cell, and iv) an optical cutoff filter which blocks the excitation beam from impinging on said signal photo-detector.

### FIELD OF THE INVENTION

This invention relates to Thermal Lens Spectroscopy (TLS) to provide ultra-sensitive absorption measurements, especially for the detection (i.e., identification) of analyte species and measurement of their concentration in micro-volumes of a carrier liquid.

### BACKGROUND OF THE INVENTION

Miniaturization has been a strong tendency in analytical systems development during at least the last decade. An important element of any analytical system based upon separation technologies is the ability to detect one or more analyte species present in low concentration in a sub-microliter volume of carrier liquid. The ability to detect a particular target analyte present at low concentration in a small detection volume becomes a critical issue especially in connection with micro-column high performance liquid chromatography (“HPLC”), and also in capillary electrophoresis (“CE”) where the detection needs to be done on an analyte sample present in a carrier liquid contained within a very small absorption cell, or within a CE capillary tube that frequently has diameter of 50 μm or less.

Traditionally, laser induced fluorescence (LIF) has been a sensitive analyte detection technique for micro-volumes due to its zero-background noise nature, and in some cases LIF permits detection of a single analyte molecule in the carrier liquid analytical volume. However, only a very limited number of analyte species have sufficient fluorescence efficiency, so fluorescent labeling or derivatization is necessary for most species. Additionally, the matrix effects associated with derivatization strongly impacts quantification capability, i.e., the ability to determine the target analyte concentration. An alternative method, namely ultra violet-Visible (“UV-VIS”) spectrophotometric absorption spectroscopy cannot provide sufficient sensitivity because of the optical path length inherent limitation of in-capillary detection. TLS, in accordance with the present invention, with its tightly focused probe beam, has intrinsic zero-background optical absorption measurement capability, and also extremely high sensitivity. TLS can therefore compete with LIF in sensitivity without its limitations as to detectable analytes.

### BRIEF DESCRIPTION OF THE DRAWINGS

FIG. 1 is a schematic which shows an optical detector configuration for ultra-sensitive detection of separated concentration peaks for plural analyte samples present in small volumes of a carrier liquid (in this case present in a capillary tube) using TLS.

FIG. 2 is a graph which shows the time dependence of a Thermal Lens signal.

FIGS. 3a and 3b show two alternative relationships of the probe and excitation beams in conjunction with Thermal Lens imaging, also in accordance with the present invention.

FIG. 4 illustrates an alternative arrangement in accordance with the present invention for the probe and excitation beams which arrangement incorporates a reference photo detector such as a photo-diode.

FIG. 5 illustrates an alternative arrangement, again in accordance with the present invention, for the probe and excitation beams which reverses the position of the cutoff filter and the aperture relative to the signal photo-diode.

FIG. 6 shows an embodiment of the present invention which includes a rejection filter and an additional photo-detector making it suitable for fluorescence or Raman detection

FIG. 7 illustrates, via a pair of graphs showing the spectra of a target analyte that manifests both absorption and a fluorescence (or Raman) signal.

FIGS. 8a and 8b show a comparison of chromatograms obtained with a current state-of-the-art UV-VIS detector (Shimatzu SPD10AVvp), and a thermal lens detector in accordance with the current invention as shown schematically in FIG. 1.

FIGS. 9a and 9b show the comparative results obtained for 15 amino acids when using a prior art P/ACE-22-0 spectrometer and a TLS instrument in accordance with the present invention.

### DESCRIPTION OF THE INVENTION

Although the basic principle of TLS were reported by M. Tokeshi, M. Uchida, A. Hibara, T. Sawada and T. Kitamori in “Determination of Submicromole Amounts of Nonfluorescent Molecules Using a Thermal Lens Microscope: Subsingle-Molecule Determination” Anal. Chem. 73, 2112-2116 (2001), this prior art reference provides neither an apparatus nor method possessing the advantages of the present invention which, depending on the particular embodiment selected, include:
The relative noise in one embodiment of the current invention closely approaches the shot noise limit for the probe beam, which results in a signal to noise ratio of 5×10⁻⁸ for a probe beam power of only 0.25 mW This relative noise improvement is achieved by removing the excess noise components from the probe beam by using a second photodetector.
In the current invention the unwanted effect of the cell window or capillary wall absorption is reduced by approximately a factor of 10 due to optimized off-axis beam geometry.
The identification of fluorescing analytes is facilitated by adding a second registration channel (emission channel) and using the coincidences between the absorption and fluorescence peaks.
The provision of two registration channels in the present invention also gives it a unique possibility to provide the calibration of fluorescent and Raman signals by referencing these emission signals to the absorption signals for any species that manifests optical absorption, thus providing a calibration factor for the particular instrument.
According to one embodiment of the present invention, the use of a high repetition rate pulsed excitation beam source provides the capability to detect species that are normally non absorbing at the excitation wavelength by using two-photon absorption. This makes the method of the present invention truly universally applicable since all substances manifest two-photon absorption.

An optical detector in accordance with the present invention is particularly suitable and advantageous for use in detecting concentration peaks on the output of a separation analytical tool such as HPLC (high performance liquid chromatography) or CE (capillary electrophoresis). Distinguishing features of my thermal lens detector are its very high sensitivity, ability to utilize an extremely small (sub-nL) carrier liquid volume, immunity to optical source noise and self-calibration of the time axis. My detector is based upon local change (i.e., change in the area of maximum excitation beam energy density) of the refractive index of the carrier liquid containing the target analyte sample thereby causing the carrier liquid to act as a microscopic thermal lens, which change is induced by the analyte's absorption of a focused beam (the “excitation beam”) at a pre-determined wavelength of interest (i.e., a distinctive absorption wavelength of the target analyte or analytes known or believed present in the carrier liquid). In operation the excitation beam is focused either into a quartz sample cell connected to a separation column when used in conjunction with HPLC, or directly into the capillary of a CE system, which capillary serves as an optical cell.

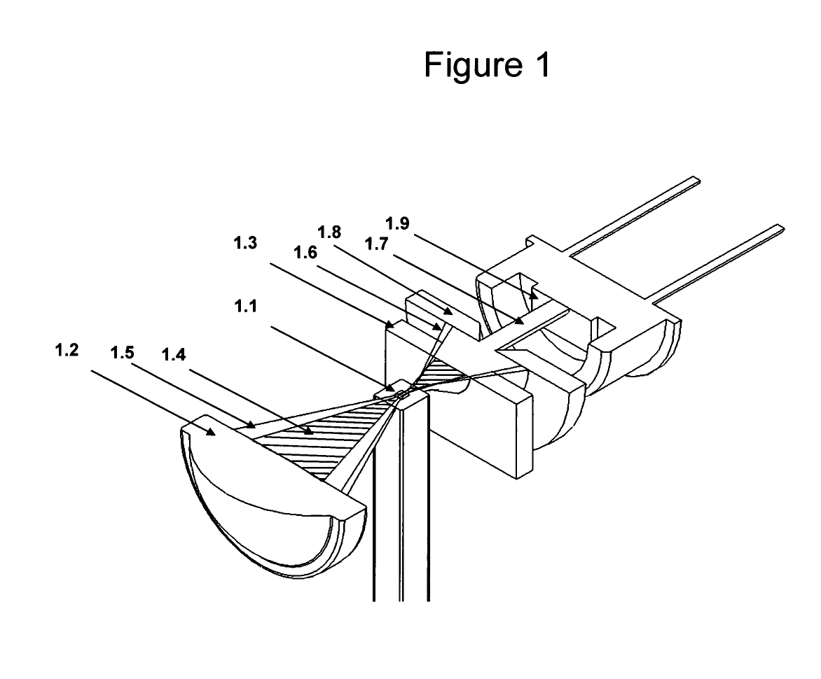

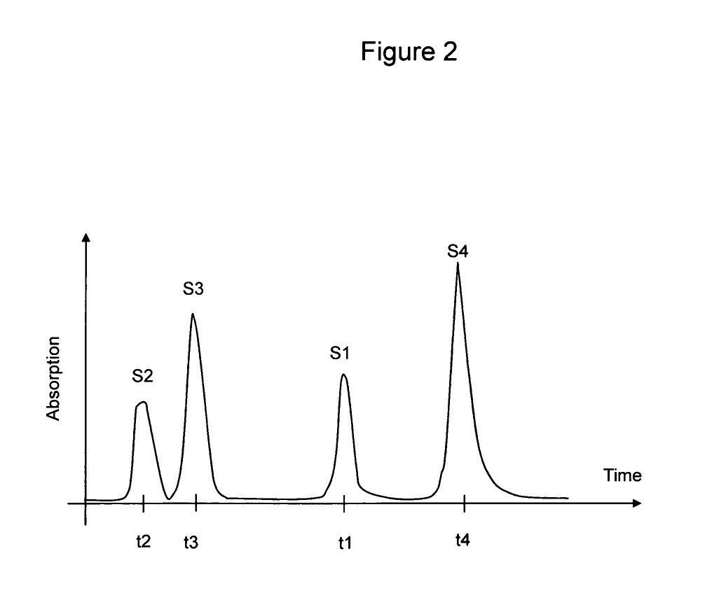

In HPLC the diameter of the focused excitation beam at the window of the cell containing the carrier liquid will preferably be not bigger than about 20 μm. The cell length will preferably be not bigger than about 100 μm, which results in a sample volume of less than about 50 pL (50×10⁻¹² liter). When an absorbing species (in the case of either HPLC or CE separation) is present in the area of the cell or capillary illuminated by the excitation beam, the microscopic thermal lens, whose strength is proportional to the absorbed excitation beam power will change the divergence of a second laser beam, (the “probe beam”). This divergence change will result in a change in the optical power incident on a photo-detector having an aperture interposed between it and the source of the probe beam. This will, in turn, cause the photo-detector output signal to change, which change will be hereinafter referred to as the “thermal lens signal” or “TL signal”. The TL signal from the photo-detector is detected synchronously using, for example, a lock-in amplifier to thereby provide a signal which is proportional to the absorbed power of the excitation beam (which in a preferred embodiment will be at a UV wavelength of from about 200 to 350 nm). Where there is more than one target analyte, the excitation beam wavelength will be selected to coincide with an absorption wavelength of all the target analytes. From the time dependence of the TL signal the target analyte species can be identified using time coordinates, and the peak area or peak amplitude can provide the target analyte concentration. In FIG. 1 the following elements are shown in their appropriate arrangement in connection with the practice of the present invention. In FIG. 1 the capillary (1.1) contains the target analyte, lens 1.2 to focus the probe and excitation beams indicated as 1.5 and 1.4, respectively, into the interior of the capillary, as shown. Also shown is the thermally perturbed probe beam (1.6) after its passage through the capillary containing analyte, the filter which prevents passage of the excitation beam after passage through the capillary is designated 1.3, the post passage beam is designated 1.7 and the aperture which limits the beam impinging on photo-detector 1.9 is designated 1.8. In FIG. 1 and in the subsequent Figures conventional components are not included for purposes of clarity. For example, the probe and excitation beam source lasers are not shown, nor is the conventional electronic circuitry including a photo-detector amplifier and the signal processing circuitry which converts the light incident on the signal photo-diode into an output signal which shows the absorption wavelength and concentration of the target analytes as shown in FIG. 2.

A graph illustrating the aforementioned time dependence is shown in FIG. 2. An example of thermal lens signals from a sample consisting of four different analyte species, S1 through S4, will have four peaks as is shown in FIG. 2. As can be seen, the first peak belongs to species S2, which appears at a time t2, the second peak at time t3 belongs to species S3, and so forth. The time t2 is called “migration time” for species S2 and so on. The times t1 through t4 can be determined in a calibration run with known concentrations of the species S1 through S4. The peak heights and the peak areas are proportional to the species concentration and also depend on the absorption coefficients of the species, and on the properties of the buffer liquid. Once the proportionality coefficients of the peak heights and areas, as well as migration times for all analyte species of interest have been determined from a calibration run, each of the various analyte species can be identified by their migration times, and their concentrations can be determined from the proportionality coefficients of their respective peaks.

In TLS in accordance with the present invention, an excitation beam at a wavelength different from that of the probe beam (preferably having a wavelength shorter than the wavelength of the probe beam) is focused on a spot within, for example, an HPLC optical cell or a CE capillary channel (which capillary channel can be deemed an optical cell for purposes of this invention). The energy absorbed by the carrier liquid containing the target analyte (sometimes referred to as the “buffer” liquid) causes heating within a small region of the carrier liquid containing the target analyte, as explained in further detail below. The heated region is defined in the transverse direction by the focused excitation beam diameter (normally a few micrometers) and along the excitation beam axis the heated region will extend from the focal plane by about one Rayleigh length or less in the case where the beam path through the liquid contained in the cell is less than one Rayleigh length. In a preferred embodiment the excitation beam focus diameter will have a Rayleigh Range approximately equal to the length of liquid through which the beam passes along the beam axis. It is this local heating which creates a thermal lens due to the refractive index temperature dependence of the buffer liquid.

Such a thermal lens can be detected by a probe beam having a different wavelength which probe beam is also directed into the same sample volume. The divergence of the probe beam as a result of passing through the thermal lens will slightly increase, as is shown in FIG. 1, and the portion of the probe beam which is transmitted through a small aperture and which then impinges on a signal photo-detector will thus decrease. The photo-detector will preferably be a photo-diode, although other photo-detectors as are known in the art are also suitable. A long-wavelength optical pass filter which blocks the shorter wavelength excitation beam can serve to block the excitation radiation from impinging on this photo-detector.

In traditional UV-VIS absorption spectroscopy one measures the absorbed fraction of the light intensity ΔI/I₀≈1−10^{-A}=1−e^{-αL}≈αL, where I₀ is the light intensity without absorption, α is the absorption coefficient, and A=cεL provides the absorbance of a solution of a sample of a length L with molar extinction ε and concentration c. In contradistinction, in TLS in accordance with the practice of the present invention, one measures the relative change of the probe beam signal intensity ΔI/I₀ due to the thermal lens created by the excitation beam. This change depends on the excitation beam power P_{E}, thermal conductivity k of the medium, (i.e., carrier liquid containing the target analyte), the probe beam wavelength λ_{P} and the temperature derivative of the medium refractive index dn/dT as:

$$Δ I / {I}_{0} = \frac{{P}_{E} \frac{d n}{d T}}{k {λ}_{P}} α L .$$

One can thus see that the TLS signal is proportional to the sample absorption αL. The proportionality factor E:

$$E = \frac{{P}_{E} \frac{d n}{d T}}{k {λ}_{P}}$$

can be referred to as the “Thermal Lens Enhancement Factor”, and indeed the relative change of the probe beam intensity can be larger than the classical absorption signal. For example, if one takes typical parameters for water, one finds that E=1 for a probe beam wavelength of 633 nm and an excitation beam power of only 4.2 mW. For excitation beam power values exceeding 4.2 mW the thermal lens signal will be significantly stronger than that of a classical absorption signal.

The excitation beam is preferably focused into the cell such that the beam's Rayleigh length (normally referred to as Zᵣ) is chosen to be close to the cell length along the excitation beam propagation direction and its waist position is in the center of the cell. The probe beam is preferably focused to a diameter comparable to that of the excitation beam and the probe beam Rayleigh length will preferably be comparable to that of the excitation beam. However, the probe beam waist position, unlike the waist position of the excitation beam, will preferably not coincide with the excitation beam waist position but rather will be positioned several Rayleigh lengths (ranges) either behind or in front of the excitation beam waist. The Rayleigh length is defined as: Zᵣ=f₁w₀²n/λ where w₀ is the beam waist radius, n is the refractive index of the medium containing the analyte and λ is the wavelength of the probe beam.

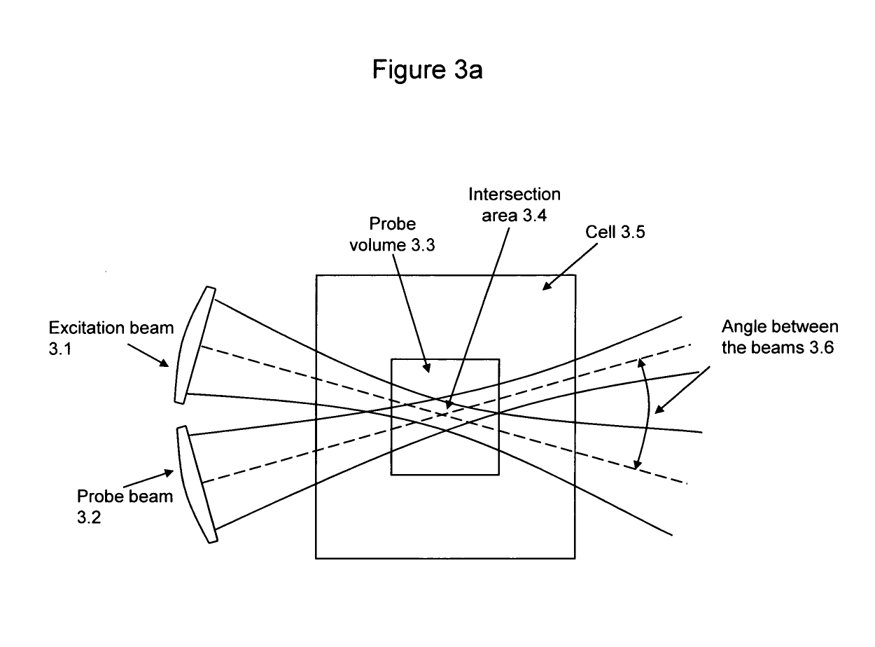

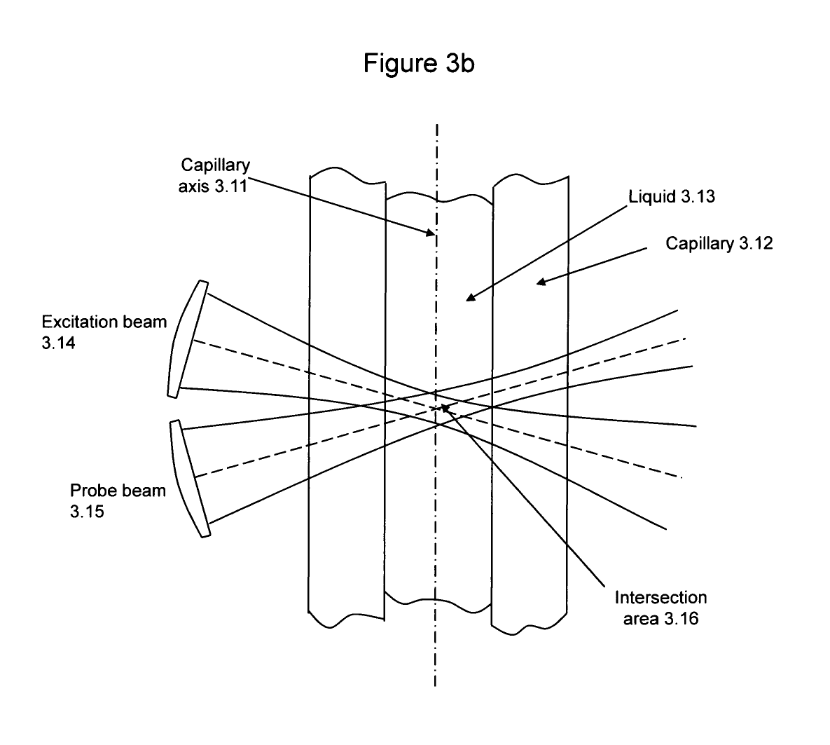

The overlap of the two beams is selected to give the maximum signal to noise ratio and hence the optimal thermal lens response. According to my invention, the beam axis of the probe beam is set at an angle to the axis of the excitation beam, such that the two beams overlap substantially or fully only within that part of the cell filled with the liquid containing the target analyte, but the two beams have at most limited overlap in the cell window. Such an arrangement of the excitation and probe beams is shown in FIG. 3a. In FIG. 3a the excitation beam and the probe beam are designated as 3.1 and 3.2, respectively. The two beams intersect in the probe volume containing the analyte (3.3) within the cell (3.5), which can be either a capillary (in the case of capillary electrophoresis) or a specially designed cell, as is used, for example, in the case of HPLC. Cell 3.5 contains the analyte(s) in a carrier liquid, and the intersection area of the beams is designated as 3.4. In a preferred embodiment, the angle (3.6) between two beams will be in the range of 20° to 40°. With such an alignment the loss of the useful signal from the liquid does not exceed about 30%, and the unwanted signal from absorption by the cell window material is reduced by at least one order of magnitude.

In some cases the reflection of the reference beam or of some part of it back to the probe beam source may occur, and such reflection can result in increased amplitude noise of the probe beam. In order to reduce the probability for such noise to occur, in an alternative embodiment of the present invention the probe beam and the excitation beam can both be advantageously directed along the capillary, i.e., the axis of both beams are situated in the plane that contains the capillary axis as is shown in FIG. 3b. In FIG. 3b the capillary axis is designated 3.11, the capillary tube is 3.12, the analyte containing carrier liquid in the capillary tube is designated 3.13, the excitation beam is 3.14, the probe beam is 3.15 and the beam intersection area within the capillary tube along its axis is designated 3.16.

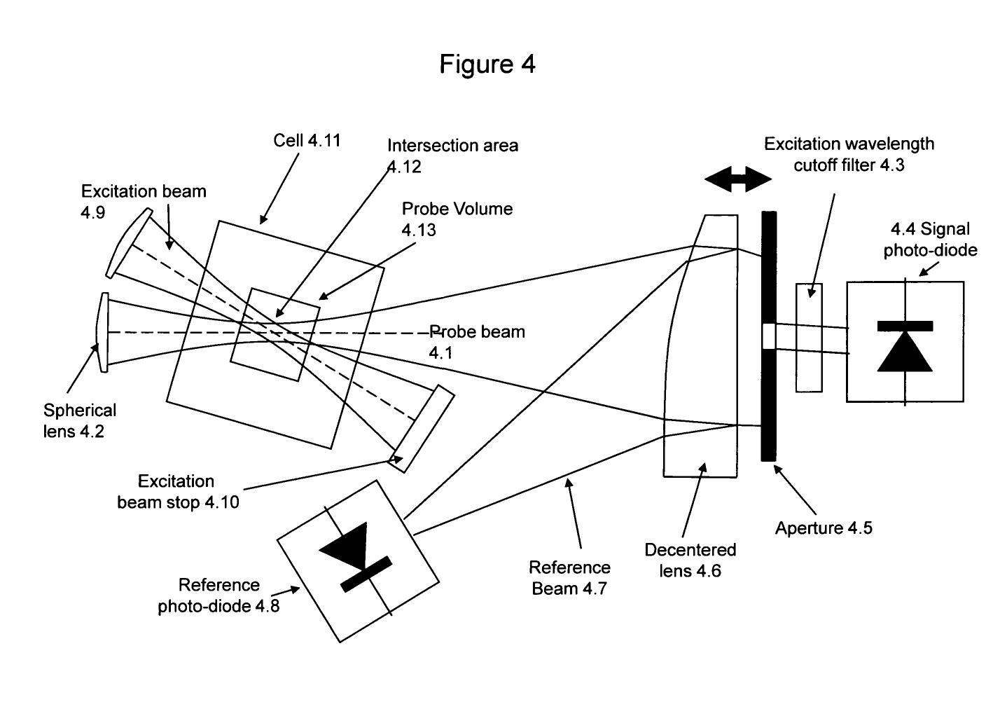

In another embodiment as shown in FIG. 4, the probe beam (4.1) is produced by a red diode laser (not shown) having a wavelength of about 635 nm and an optical power in the range of ˜1 mW to ˜20 mW. A skilled artworker will realize that other laser sources are also suitable for the probe beam, such as a He—Ne laser at ˜633 nm or a frequency doubled solid state laser such as a Nd:YAG laser which emits at ˜532 nm. The collimated probe beam is suitably focused into the cell by a spherical lens (4.2). As shown, the diverging probe beam outcoming from the cell passes through an excitation beam wavelength cutoff filter (4.3) and is incident onto a signal photodiode (4.4), e.g. a silicon photodiode. A small aperture (4.5) is preferably placed in front of the signal photodiode so that only a few percent of the power of the probe beam reaches the signal photodiode. In a preferred embodiment an off-axis plano-convex (decentered) lens (4.6) is advantageously placed in front of the aperture with the flat side of the lens adjacent to the aperture, such that a small percentage of the probe beam is reflected back in the general direction of the probe laser to thereby provide a “reference beam” (4.7). The reflected portion of the probe beam will be focused due to its double passage through the curved surface of the off-axis lens. An additional photodiode (the “reference photodiode” 4.8) is suitably placed in the focal spot of the reflected probe beam. By traversing the signal photodiode, the aperture (4.5) and the lens (4.6) back and forth along the probe beam axis, the signal from the two photodiodes (i.e., signal and reference) can be readily adjusted to have the same value so that any power fluctuations of the reference beam source will cause equal signal changes in both photodiodes. The two photodiodes (photo-detectors) are preferably connected in series and negatively biased so that the cathode of the signal photodiode is connected to the positive power supply voltage, and the anode of the reference photodiode is connected to a negative power supply. The excitation beam is shown as 4.9 and a non-reflecting excitation beam stop is designated 4.10. The cell, beam intersection area and probe volume are designated 4.11, 4.12 and 4.13, respectively.

In one preferred embodiment a transimpedance amplifier (TIA) is advantageously connected to the common point of the two photodiodes so that no current enters the TIA, thus producing no output signal when no thermal lens is present. The presence of a thermal lens will cause changes in the probe beam intensity transmitted through the aperture, while the intensity of the reflected portion of the probe beam will remain unchanged because it is solely focused onto the reference photodiode. In this balanced arrangement all fluctuations of the probe beam laser power are compensated for and thus do not provide any signal. Any noise on the signal detector is therefore due only to the combined shot noise of the probe beam photocurrent and reference beam photocurrent. The noise floor of the photo-detector is larger than the signal photocurrent noise by a factor of only √2. The relative noise value is therefore equal to \sqrt{4eBi₀}, where e is the electron charge, B is the detection bandwidth, and i₀ is the average value of the signal diode photocurrent. If one assumes 4% of the total power in the signal beam and a 1 Hz detection bandwidth, then for a probe beam having 10 mW of optical power the value of the relative noise will be 8×10⁻⁸ which is more than three orders of magnitude better than the absorbance noise of existing, state of the art UV-Visible light commercial spectroscopic detection devices for use with CE or HPLC. This is a significant advantage of the present invention.

For a person skilled in optics it will be evident that a coating can be applied to the flat back surface of the off-axis lens in order to increase the fraction of the reflected probe beam that provides the reference beam and thereby further improve the signal to noise ratio of the photo-detector.

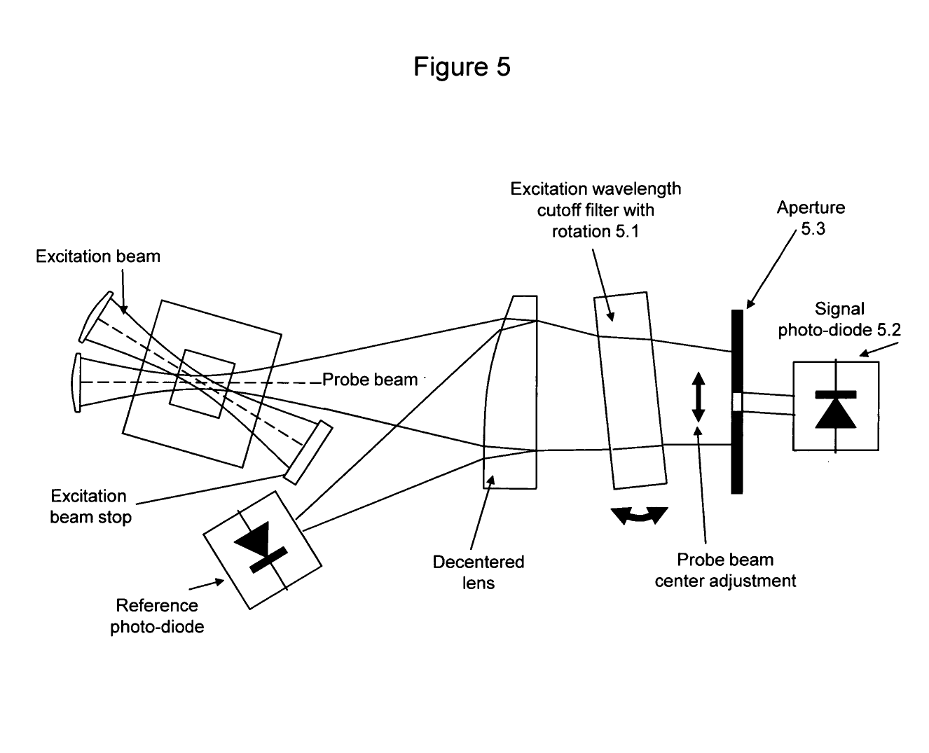

An alternative embodiment of the invention is shown in FIG. 5, which embodiment utilizes an excitation beam wavelength cutoff filter (5.1) in front of the aperture (5.3) which filter can, for example, suitably be a plane-parallel plate of colored glass having a thickness of a few mm. When the filter (5.1) is rotated by a small angle, as shown by the arrow, the transmitted probe beam displacement due to refraction in the filter can be used to center the probe beam axis on the signal photo-detector (5.2) after passage through aperture 5.3, thus providing a process for easy and high stability alignment of the probe beam versus the reference beam. In this embodiment a cutoff filter (5.1) is placed in front of the aperture. Either location for the cutoff filter is suitable. The location shown in FIG. 4, generally results in a more compact photo-detector assembly. However, the FIG. 5 arrangement facilitates balancing of the two photo-detector signals. The other components of FIG. 5 are equivalent to those shown in FIG. 4.

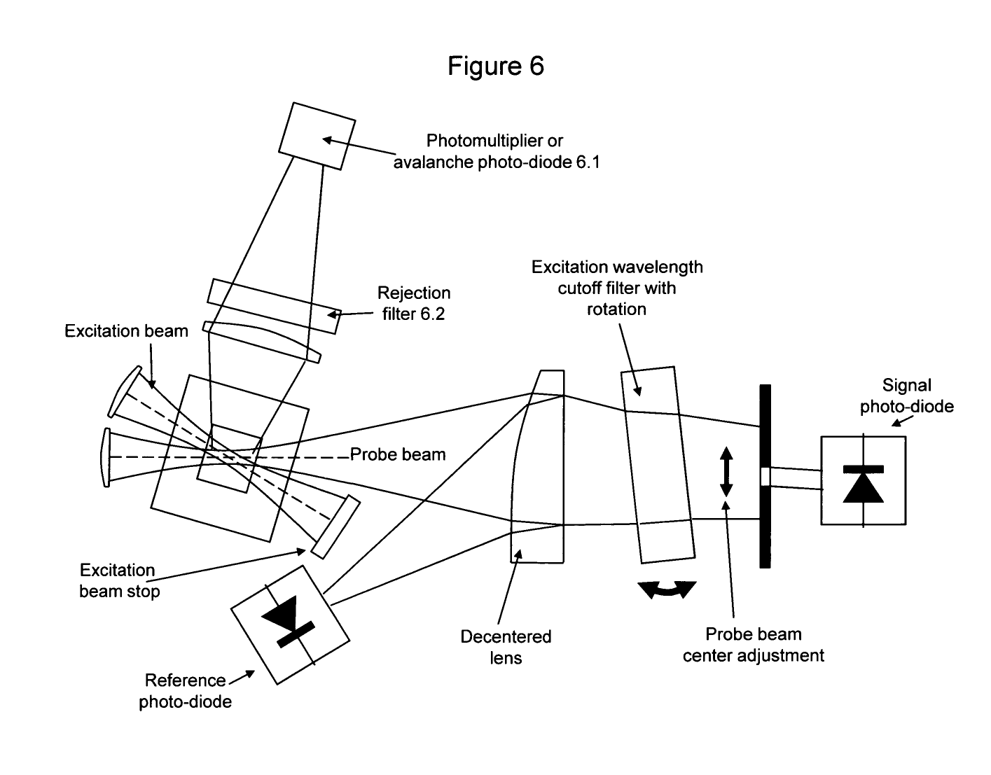

In addition to the signal and reference photodiodes as shown in FIG. 5, the optical detection system of the present invention will advantageously comprise an additional (third) high sensitivity photo-detector which can be, for example, an avalanche photodiode, or a photomultiplier tube shown as 6.1 in FIG. 6. This additional photo-detector will preferably have a dual-band rejection filter (6.2) effective to block the wavelengths of both the excitation beam and reference beam. This third detector is suitably optically coupled into the focused excitation beam area at an angle approximately normal (orthogonal) to the excitation beam axis of propagation, as shown in FIG. 6. This third photo-detector (the “emission photo-detector”) will thus be able to detect fluorescence emission (if any) and/or Raman emission of the same analyte species. Since only a few analyte species manifest significant fluorescence, such as for example phenylalanine, tryptophan and tyrosine among amino-acids, it therefore follows that only a few analytes detected by absorption using TLS in accordance with the present invention will also have fluorescence signal peaks. However, for such analytes the fluorescence signal peaks can usefully serve as an additional identification tool for these particular (or other fluorescing) species and the peaks will also provide calibration for the time axis in any individual measurement of a sample liquid containing multiple analytes.

If only absorption signals are detected, the identification of individual analyte species can be done by the time of appearance of their peaks (called “migration time” in CE). As the migration time is a function of the capillary temperature, the identification of an analyte by migration time alone requires temperature stabilization of the capillary to a small fraction of a degree, which becomes increasingly difficult the longer the capillary. The effect of the capillary temperature change is a substantial increase (or decrease) in the migration times for all analytes as a function of temperature. In order to compare two electropherograms taken at slightly different capillary temperatures one needs to re-adjust their time scales in order to make the peaks for the same species coincide. With the fluorescence signal, once the peak for a particular analyte has been identified, such time scale adjustment can readily be done. This permits one to relax significantly the requirements for the temperature stabilization of the capillary even to the extent of making temperature control unnecessary for some classes of analyte measurements.

In one embodiment of the current invention, the excitation light source is a pulsed high repetition rate laser. As an example, such source can be a diode-pumped solid-state laser having a saturable absorber inside its cavity, or a diode pumped optical fiber laser. The pulse repetition rate in such lasers can range from ˜30 to 40 kHz to ˜30 to 40 MHz, their average power can be in the range from a few mW to a few tens of mW resulting in peak power from a few hundred W to a few thousand W, and the individual pulse duration can be in the range of from a fraction of a picosecond to several nanoseconds. Such pulsed lasers are commercially available and have an affordable price and compact dimensions compared to CW lasers. The short pulse duration of such sources provides several advantages. A significant advantage of such pulsed sources, as is known in the art, is that nonlinear frequency conversion is more efficient, which makes it possible to obtain average powers from a few mW to several tens of mW at the fourth or even fifth harmonics, thereby bringing the excitation wavelength down to the deep UV range (≦˜300 nm). For amino-acid detection the wavelength of the excitation light source has a significant role, since most amino acids absorb only below 220 nm. In the case of such amino acids, I therefore prefer to use laser sources based upon nonlinear frequency conversion to provide excitation light of a UV wavelength below 220 nm.

In addition to this advantage, such a light source has an additional advantage in that the range of species that can be detected is broader because even species that have no linear absorption at the excitation wavelength will manifest two-photon absorption, and such species can therefore be detected by their two-photon absorption peaks, which would be invisible with a continuous-wave excitation light source. This is possible because a pulsed laser light source provides significantly higher (by several orders of magnitude) peak power. It is, of course, well known to the skilled artworker that two-photon absorption is proportional to the square of the peak power, e.g., a pulsed laser peak power 10³ higher than a CW laser provides a two photon signal 10⁶ stronger than for a CW laser of the same average power.

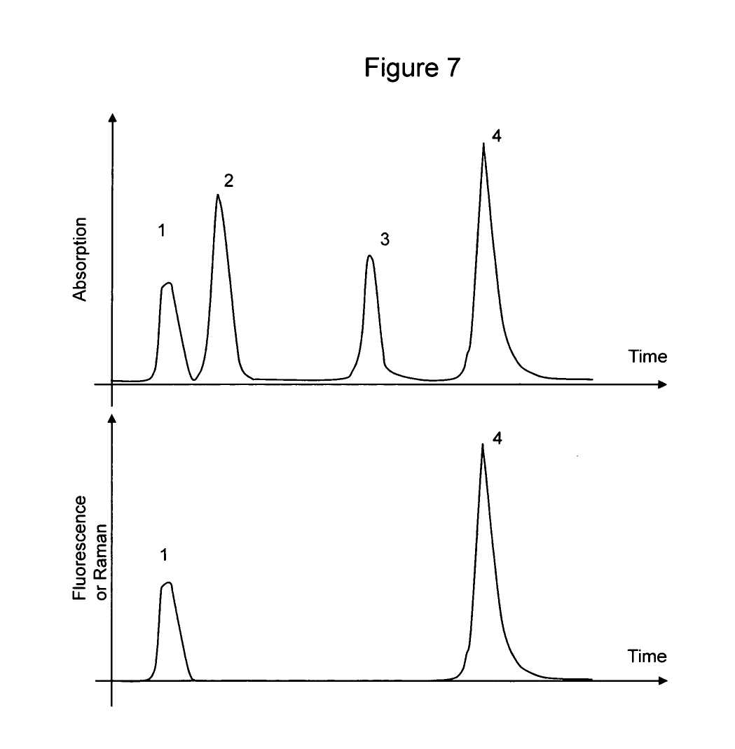

Even though there may be species that have no linear absorption even in the deep UV range, all analyte species show unique Raman spectra corresponding to its molecular vibrations. This feature provides the capability of detecting virtually any species. However, both two-photon and Raman signals can be more difficult to calibrate for quantitative measurements. In the present invention however, the TL signal in this instance provides the additional feature of providing intensity calibration using simultaneously Raman spectra and optical absorption as shown in FIG. 7. This provides an internal reference to both Raman and two-photon measurements. However, note that only analyte species 1 and 4 manifest fluorescence and thereby permit absorption peak identification and time calibration with the fluorescent signal.

Besides the sensitivity enhancement, TLS in accordance with the present invention has the following important advantages:
High power excitation sources in the UV range are normally based upon nonlinear frequency conversion techniques, and are thus very noisy. Typical intensity noise values for such lasers are in the range of a few %. In contrast to this, the probe laser of the present invention can be very quiet. Contemporary red diode lasers, for example, can have their intrinsic noise close to the shot noise, which means that for a probe beam power reaching the photo-detector of only 1 mW, the relative probe beam intensity change ΔI/I₀=4×10⁻⁸ can be detected within a one Hertz detection bandwidth. This is more than two orders of magnitude better than the best contemporary CE detection instruments based upon classical UV-VIS spectroscopy, even without taking into account the additional TLS enhancement factor.
TLS measures the absorption coefficient of the buffer medium locally, e.g., within the middle of the capillary or HPLC cell, thus reducing the effects of the capillary wall or cell wall material, which can sometimes be very significant, especially in the deep UV spectral range.
The TLS detection system of the present invention is very compact, and it can work directly on the CE capillary. (Note that the capillary cross-sectional dimension is generally only about 0.34 mm. My instrument can therefore be packaged in a small detection unit (as shown, for example, in FIG. 1) similar to the packages used in telecommunications, thus providing exceptional stability and reproducibility.

All this makes TLS superior in accuracy even compared to other highly sensitive methods of absorption measurement such as Cavity Ring-Down Spectroscopy (CRDS). This can be seen from a comparison of the application of TLS to an HPLC separation column with the application of CRDS to the same system, as reported in K. Bechtel, R. Zare, A. Kachanov, S. Sanders and B. Paldus, “Moving beyond Traditional UV-Visible Absorption Detection: Cavity Ring-Down Spectroscopy for HPLC”, Anal. Chem. 77, 1177-1182 (2005). Such a comparison also illustrates an additional value of TLS system calibration in terms of measured absorption. CRDS is a direct absolute absorption method, in that it provides quantitative absorption data that can be used for this purpose. In the previous CRDS work, the same laser excitation light source at 488 nm (as is also suitable for the practice of the present invention) was used, which thus permits a direct comparison between classical UV-VIS absorption, CRDS and TLS. Five anthraquinone dyes which absorb in the blue spectral region were used in this experiment. The detection wavelength was 632.8 nm. The results and performance specifications in this experiment can be readily extended for other excitation wavelengths because of the universally applicable character of the thermal lensing effect.

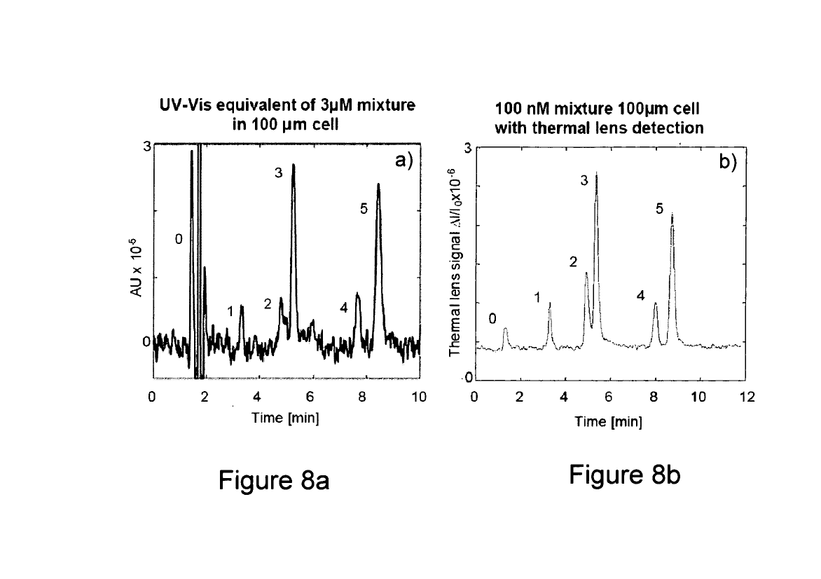

The TLS potential can be understood from a consideration of FIGS. 8a and 8b. The labeled peaks designate: 0—solvent front, 1—alizarin, 2—purpurin, 3—quinalizarin, 4—emodin, and 5—quinizarin. In FIG. 8a a HPLC separation run detected with an industry standard UV-VIS detector is shown. The absorption cell length was 10 mm, and the concentrations of the five anthraquinone dye species were 0.03 μM in each case. It is equivalent to an absorption pattern that would be produced by running a sample containing an analyte at a 100 times higher concentration in a 100 times shorter cell. The thermal lens detection results shown in FIG. 8b were made in a 100 μm thick fused silica cell with a 100 nanomolar concentration of the same five anthraquinone dyes species. The noise in the UV-VIS detector at three standard deviations (3σ) level is about 2×10⁻⁶ Absorbance Units (AU), which corresponds to a signal to noise ratio of 14 for analyte component 1 (Alizarin). The limit of detection for Alizarin by UV-VIS for such a cell then would be about 0.2 μM. For thermal lens detection as shown in FIG. 8b, the background noise at 3σ level is about 5×10⁻⁸, which corresponds to a signal to noise ratio for 100 nM of Alizarin of about 46. Thus the minimum detectable concentration of Alizarin using TLS is 2.1 nM, which is ˜100 times better than is obtainable with UV-VIS.

Substantially similar performance for TLS detection can be obtained for a fused silica capillary with a channel cross section of 50 μm, (an industry standard size in CE) based upon the fact that the actual probe volume size in another TLS measurement was 20 μm in diameter, i.e., significantly smaller than the 50 μm capillary channel size. When detecting a species in CE, the advantage of TLS will be even greater, as compared to HPLC. The very small capillary cross-section makes light collection from conventional small-area deuterium arc lamps less efficient than in HPLC, and therefore the baseline noise in CE devices with UV-VIS detection is higher than in HPLC. According to my measurements, the 3σ baseline noise in an industry standard CE instrument (Beckman P/ACE-2200) is 3×10⁻⁵ AU. Therefore the expected gain in performance of TLS versus UV-VIS in CE can reach three orders of magnitude.

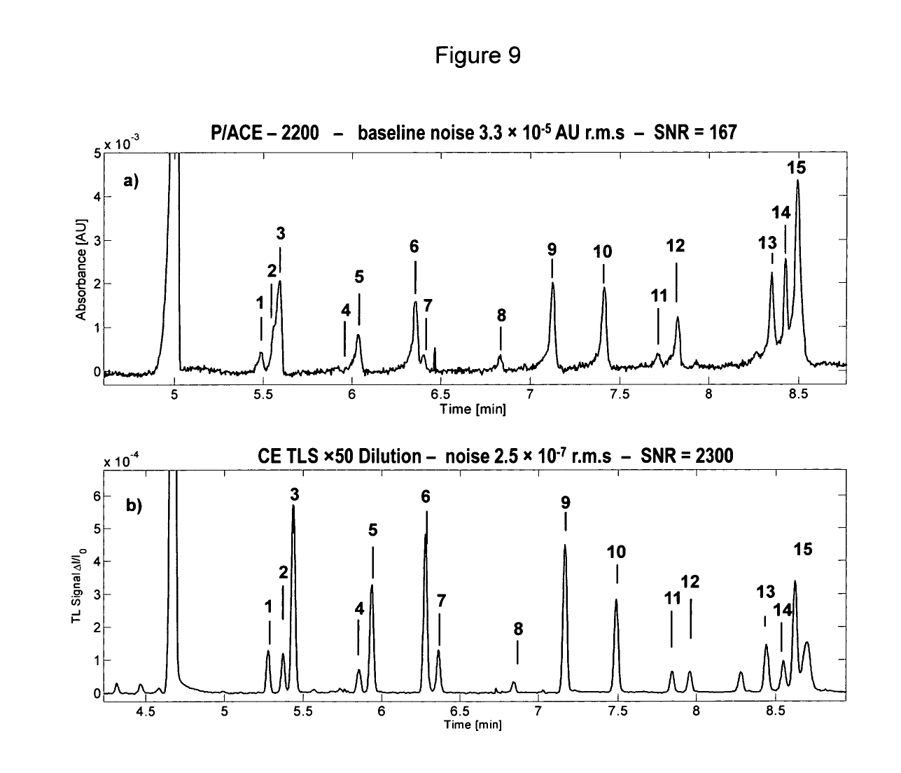

This can be seen from back-to-back comparison of the measurements of 15 amino-acids made with Beckman P/ACE-2200 instrument and a TLS detection system in accordance with the present invention, the results of which are shown in FIGS. 9a and 9b. The trace 9a presents the results of a CE separation of a standard sample of 15 amino-acids on P/ACE-220, and the trace 9b shows the separation of the same sample but diluted 50 times on the CE TLS detection system. The much better performance of the TLS system can be seen from this comparison. The signal to noise ratio in trace 9a is 167 versus 2300 in trace 9b). Taking into account ×50 dilution of the sample in trace 9b we conclude that the sensitivity of the TLS detector is about 700 times better. Moreover, the resolution of the TLS detector due to smaller analytical volume is superior to that of the P/ACE-2200. The peaks 1-2-3, 4-5 and 6-7 are only partially resolved with P/ACE-2200 but are completely resolved with the TLS system.

The list of amino-acids, their concentrations in the standard sample and in the diluted sample as well as the limits of detection (LOD) are presented in the Table 1. One can see that detection of amino-acids in nano-molar range are now possible with TLS.

TABLE 1

| | | | Signal | |
|---|---|---|---|---|
| | [C] in Standard | [C] in TLS | to Noise | |
| | Sample | Sample | Ratio | LOD |
| Amino Acid | [mM] | [μM] | (TLS) | [nM] |
| 1 - Thr (Threonine) | 16 | 0.8 | 521 | 31 |
| 2 - Ser (Serine) | 9.6 | 0.48 | 462 | 21 |
| 3 - Gln (Glutamine) | 80 | 4 | 2292 | 35 |
| 4 - Cys (Cysteine) | 10.4 | 0.52 | 299 | 35 |
| 5 - Gly (Glycine) | 10.6 | 0.53 | 1310 | 8 |
| 6 - Val (Valine) | 16 | 0.8 | 1923 | 8 |
| 7 - Tyr (Tyrosine) | 11.4 | 0.57 | 513 | 22 |
| 8 - Met (Methionine) | 4 | 0.2 | 122 | 33 |
| 9 - Ile (Isoleucine) | 16 | 0.8 | 1790 | 9 |
| 10 - Leu (Leucine) | 16 | 0.8 | 1111 | 14 |
| 11 - Trp (Tryptophan) | 1.6 | 0.08 | 240 | 7 |
| 12 - Phe (Phenylalanine) | 8 | 0.4 | 240 | 33 |
| 13 - His (Histidine) | 5.4 | 0.27 | 572 | 9 |
| 14 - Lys (Lysine) | 20 | 1 | 373 | 54 |
| 15 - Arg (Arginine) | 9.6 | 0.48 | 1348 | 7 |

1. A thermal lens detection apparatus comprising:
i) an optical cell for containing at least one target analyte present in a carrier liquid,
ii) a probe beam having a pre-determined wavelength,
iii) an excitation beam having a pre-determined wavelength shorter than that of the probe beam, said excitation beam having a Rayleigh length approximately equal to the radius of said optical cell,
the beam axis of said probe beam and the beam axis of said excitation beam being at an angle to each other, but both said probe beam and said excitation beam being focusable so that their beams overlap in the interior portion of the optical cell,
iv) a signal photo-detector for receiving at least a portion of said probe beam signal after its passage through said optical cell, and
v) an optical cutoff filter which blocks the excitation beam from impinging on said signal photo-detector.

2. An apparatus in accordance with claim 1, wherein the probe beam Rayleigh length is approximately equal to the Rayleigh length of the excitation beam and the probe beam is focused to a diameter substantially equal to the diameter of the excitation beam.

3. An apparatus in accordance with claim 1, wherein the excitation beam is focused into the cell such that its Rayleigh length is close to the cell length along the excitation beam propagation direction and its waist position is in the center of the cell.

4. An apparatus in accordance with claim 1, wherein the probe beam waist position is positioned several Rayleigh lengths either behind or in front of the optical cell.

5. An apparatus in accordance with claim 1, wherein the angle between the probe beam and the excitation beam is in the range of 20° to 40°.

6. An apparatus in accordance with claim 1, further comprising:
i) a spherical lens,
ii) an aperture situated in front of said signal photo-detector.

7. An apparatus in accordance with claim 6, further comprising:
i) an off-axis plano-convex lens situated in front of the aperture with the flat side of the lens adjacent to the aperture, whereby a portion of the probe beam is reflected back in the direction of the probe beam source to thereby provide a reference beam, and
ii) a reference photo-detector placed in the focal spot of the reference beam.

8. An apparatus in accordance with claim 6, further comprising:
an excitation wavelength cutoff situated in front of said aperture.

9. An apparatus in accordance with claim 7, wherein the signal photo-detector, the aperture and the spherical lens are traversable along the probe beam axis, and the signal photo-detector and the reference photo-detector are connected in series and negatively biased.

10. An apparatus in accordance with claim 7, wherein said signal photo-detector, said aperture and said off-axis plano-convex lens are traversed along the axis of said probe beam until the signals from said signal photo-detector and said reference photo-detector have the same value

11. An apparatus in accordance with claim 7, wherein a transimpedance amplifier is connected to the connection point of the signal photo-detector and the reference photo-detector.

12. An apparatus in accordance with claim 7, further comprising a third photo-detector and a dual-band rejection filter effective to block the wavelengths of both the excitation beam and reference beam from impinging on said third photo-detector.

13. An apparatus in accordance with claim 12, wherein said third photo-detector is optically coupled into the focused area of the excitation beam at an angle approximately orthogonal to the excitation beam's axis of propagation.

14. An apparatus in accordance with claim 1, further comprising a second excitation beam source and wherein said carrier liquid contains at least one target analyte which fluoresces at the emission wavelength of said second excitation beam.

15. An apparatus in accordance with claim 1, further comprising a second excitation beam source and wherein said photo-detector is configured to record the Raman signal emitted by at least one target analyte present in the carrier liquid.

16. An apparatus in accordance with claim 1, wherein the photo-detector signal is connected to a lock-in amplifier.

17. An apparatus in accordance with claim 1, wherein the excitation beam has a wavelength ranging from about 200 nm to 350 nm.

18. An apparatus in accordance with claim 1, wherein the axis of the excitation beam and the axis of the probe beam overlap substantially within that portion of the optical cell containing the target analyte.

19. An apparatus in accordance with claim 1, wherein said target analyte is present in a capillary tube and wherein the axis of said excitation beam and the axis of said probe beam are oriented in the plane that contains the axis of said capillary tube.

20. An apparatus in accordance with claim 1, wherein the excitation beam source is a pulsed, diode-pumped solid-state laser having a pulse repetition rate ranging from a few tens of kHz to a few tens of MHz, and an average power in the range of from a few mW to a few tens of mW corresponding to peak power in the range from a few hundred W to a few thousand W, and a pulse duration in the range of from a fraction of a picosecond to several nanoseconds.

21. An apparatus in accordance with claim 1, wherein the excitation beam source is a pulsed, diode-pumped solid-state laser having an average power in the range from a few hundred mW to a few thousand mW, and a pulse duration in the range of from a fraction of a picosecond to several nanoseconds.
